(19) United States
(12) Patent Application Publication
(10) Pub. No.: US 2021/0082635 A1
(43) Pub. Date: Mar. 18, 2021

(54) ELECTROLYTE OF ENERGY STORAGE DEVICE, ENERGY STORAGE DEVICE, AND MANUFACTURING METHOD OF ENERGY STORAGE DEVICE

(71) Applicant: AISIN SEIKI KABUSHIKI KAISHA, Kariya-shi (JP)

(72) Inventors: Kotaro MIZUMA, Kariya-shi (JP); Shinnosuke INAMI, Kariya-shi (JP); Shigeru SUEMATSU, Kariya-shi (JP); Da LI, Kariya-shi (JP); Gang XIE, Kariya-shi (JP)

(73) Assignee: AISIN SEIKI KABUSHIKI KAISHA, Kariya-shi (JP)

(21) Appl. No.: 17/017,064

(22) Filed: Sep. 10, 2020

(30) Foreign Application Priority Data
Sep. 12, 2019 (JP) 2019-165976

(51) Int. Cl. H01G 11/60; H01G 11/86; H01G 11/06; H01G 11/62; H01G 11/32

(52) U.S. Cl. CPC H01G 11/60; H01G 11/86; H01G 11/32; H01G 11/62; H01G 11/06

(57) ABSTRACT

An electrolyte of an energy storage device includes a non-aqueous solvent, an electrolyte salt including LiPF₆, and at least two compounds selected from among a phosphite ester compound represented by a formula 1, a compound configured to form lithium and a complex and including a formation constant equal to or greater than 10², difluorophosphate represented by a formula 2, and a phosphate ester compound represented by a formula 3, the at least two compounds including at least the phosphite ester compound represented by the formula 1:

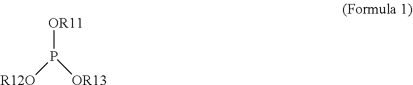

where each of R11, R12, and R13 is independently one of a monovalent hydrocarbon group and a monovalent fluorinated hydrocarbon group,

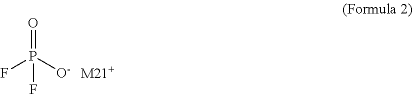

where M21⁺ is one of lithium ion (Li⁺) and sodium ion (Na⁺),

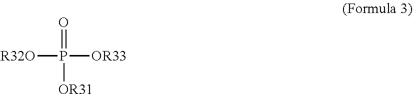

where each of R31, R32, and R33 is independently one of a monovalent hydrocarbon group and a monovalent fluorinated hydrocarbon group.

### CROSS REFERENCE TO RELATED APPLICATIONS

This application is based on and claims priority under 35 U.S.C. § 119 to Japanese Patent Application 2019-165976, filed on Sep. 12, 2019, the entire content of which is incorporated herein by reference.

### TECHNICAL FIELD

This disclosure generally relates to an electrolyte of an energy storage device, the energy storage device, and a manufacturing method of the energy storage device.

### BACKGROUND DISCUSSION

An energy storage device such as a lithium ion capacitor and a lithium ion secondary battery is used for a power source of a hybrid car and an electric car, for example. An electrolyte serving as a component of such energy storage device and a manufacturing method thereof have been actively developed.

JP2006-269459A discloses an electrolyte for an electric double-layer capacitor, the electrolyte including specific pyrazolium composite salt that indicates high conductivity within a wide temperature range from low to high temperatures, for example.

JP2000-200739A discloses a manufacturing method of an electric double-layer capacitor including a high-temperature aging process, for example. During the high temperature aging process, the electric double-layer capacitor is applied with a higher voltage than a usage voltage under temperature environment of 60° C. or more and is left for a predetermined time period (for example, two to twenty-four hours) during which gas within a case of the capacitor is suctioned and discharged to the outside. This resolves and eliminates water occluded at carbon fibers or carbon fine powders forming an electrode and serving as a source of carbon dioxide and also resolves and eliminates specific functional groups that is arranged at the surface of the carbon fibers or the carbon fine powders and that are resolved to generate water. The internal pressure at the case is restrained from increasing by possible generation of carbon dioxide. Characteristics of the electric double-layer capacitor are thus restrained from decreasing.

In a case where lithium hexafluorophosphate (LiPF₆) including less thermal stability is used as an electrolyte salt in electrolyte of an energy storage device, the energy storage device is known to be possibly deteriorated due to degeneration or change in quality of the electrolyte at high temperature. The energy storage device using such electrolyte is desired to be restrained from deteriorating at high temperature.

A need thus exists for an electrolyte of an energy storage device, the energy storage device, and a manufacturing method of the energy storage device which are not susceptible to the drawback mentioned above.

### SUMMARY

According to an aspect of this disclosure, an electrolyte of an energy storage device includes a non-aqueous solvent, an electrolyte salt including LiPF₆, and at least two compounds selected from among a phosphite ester compound represented by a formula 1, a compound configured to form lithium and a complex and including a formation constant equal to or greater than 10² for forming a lithium complex, difluorophosphate represented by a formula 2, and a phosphate ester compound represented by a formula 3, the at least two compounds including at least the phosphite ester compound represented by the formula 1:

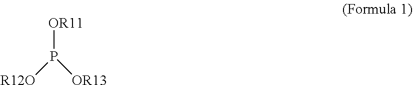

where each of R11, R12, and R13 is independently one of a monovalent hydrocarbon group and a monovalent fluorinated hydrocarbon group,

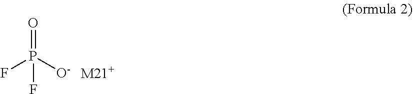

where M21⁺ is one of lithium ion (Li⁺) and sodium ion (Na⁺),

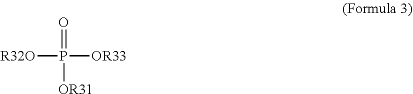

where each of R31, R32, and R33 is independently one of a monovalent hydrocarbon group and a monovalent fluorinated hydrocarbon group.

According to another aspect of this disclosure, an energy storage device includes a positive electrode including a carbon material, a negative electrode including a negative electrode material that is configured to adsorb and desorb lithium ion, and an electrolyte, the electrolyte including a non-aqueous solvent, an electrolyte salt including LiPF₆, and at least one compound selected from among a phosphite ester compound represented by a formula 4, a compound configured to form lithium and a complex and including a formation constant equal to or greater than 10² for forming a lithium complex, difluorophosphate represented by a formula 5, and a phosphate ester compound represented by a formula 6, the at least two compounds including at least the phosphite ester compound represented by the formula 4, the carbon material at which functional groups exist, the functional groups at least including a lactone group arranged at a surface of the carbon material, an amount of the phosphite ester compound contained in the electrolyte and represented by the formula 4 and a sum of amounts of a phenolic hydroxyl group and a carboxyl group existing at the carbon material and included in the functional groups satisfying a relational expression 1,

[An amount (mol) of the phosphite ester compound contained in the electrolyte and represented by the formula 4]=a1×[a sum of amounts (mol) of a phenolic hydroxyl group and a carboxyl group existing at the carbon material and included in the functional groups] (Relational expression 1)

where a coefficient a1 is equal to or greater than 1.67,

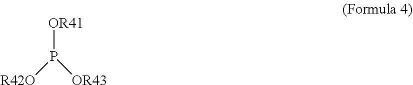

where each of R41, R42, and R43 is independently one of a monovalent hydrocarbon group and a monovalent fluorinated hydrocarbon group,

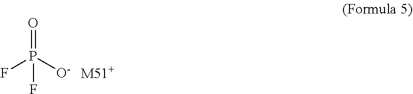

where M51⁺ is one of lithium ion (Li⁺) and sodium ion (Na⁺),

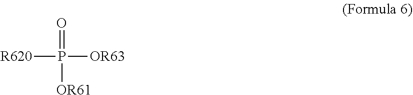

where each of R61, R62, and R63 is independently one of a monovalent hydrocarbon group and a monovalent fluorinated hydrocarbon group.

According to a further aspect of this disclosure, a method of manufacturing an energy storage device includes assembling an energy storage device including a positive electrode, a negative electrode including a negative electrode material that is configured to adsorb and desorb lithium ion, and an electrolyte, the electrolyte including a non-aqueous solvent, an electrolyte salt including LiPF₆, and at least one compound selected from among a phosphite ester compound represented by a formula 7, a compound configured to form lithium and a complex and including a formation constant equal to or greater than 10² for forming a lithium complex, difluorophosphate represented by a formula 8, and a phosphate ester compound represented by a formula 9, the at least two compounds including at least the phosphite ester compound represented by the formula 7, and performing an aging process where the assembled energy storage device is applied with a voltage and is left for a predetermined time period depending on a magnitude and a state of the applied voltage under temperature environment ranging from 80° C. to 120° C., inclusive,

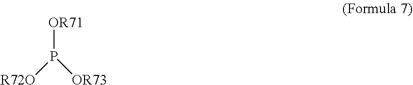

where each of R71, R72, and R73 is independently one of a monovalent hydrocarbon group and a monovalent fluorinated hydrocarbon group,

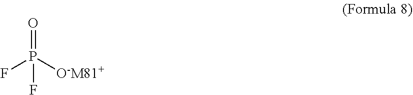

where M81⁺ is one of lithium ion (Li⁺) and sodium ion (Na⁺),

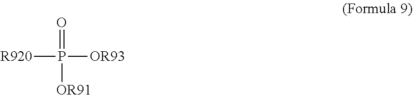

where each of R91, R92, and R93 is independently one of a monovalent hydrocarbon group and a monovalent fluorinated hydrocarbon group.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross sectional view illustrating a construction of an energy storage device according to a second embodiment disclosed here;

FIG. 2 is graph where measured results of Examples 5-1 to 5-4 and Comparison 5-1 are plotted on a coordinate with a longitudinal axis indicating an addition effect (%) of a phosphite ester compound and a horizontal axis indicating a mole percentage of an amount of lactone groups;

FIG. 3 is a graph where measured results of Examples 6-1 to 6-6 are plotted on a coordinate with a longitudinal axis indicating time for a DC-IR increasing by 50% and a horizontal axis indicating an aging time; and

FIG. 4 is a graph showing a composition analysis result by an XPS measurement of an SEI layer formed at negative electrodes of Examples 6-2, 6-3, 6-4, and 6-5.

### DETAILED DESCRIPTION

An electrolyte according to a first embodiment is explained below. The electrolyte according to the first embodiment is a non-aqueous electrolyte including an electrolyte salt, a non-aqueous solvent (organic solvent), and a specific compound. The electrolyte salt is resolved in the non-aqueous solvent. The electrolyte may further include a known additive as necessary for improving characteristics of the electrolyte. The electrolyte is appropriately used at an energy storage device such as a lithium ion capacitor and a lithium ion secondary battery, for example.

The electrolyte salt may consist of or include LiPF₆. The electrolyte salt may include other lithium salt than LiPF₆. Specifically, the electrolyte salt may include one, two, or more than two components selected from LiBF₄, Li(CF₃SO₂)₂N, LiClO₄, and others as the other lithium salt than LiPF₆, for example.

The non-aqueous solvent may include one, two, or more than two components selected from ethylene carbonate (EC), propylene carbonate (PC), ethyl methyl carbonate (EMC), diethyl carbonate (DEC), N,N-dimethylformamide (DMF), acetonitrile (AN), dimethyl sulfoxide (DMSO), dimethyl carbonate (DMC), dimethoxymethane (DMM), γ-butyrolactone (GBL), tetrahydrofuran (THF), 1,2-dimethoxyethane (DME), ethyl isopropyl sulfone (EiPS), and 1,1,2,2-tetrafluoroethyl 2,2,3,3-tetrafluoropropyl ether (HFE), for example.

The specific compound is a phosphite ester compound represented by a formula 1 as below:

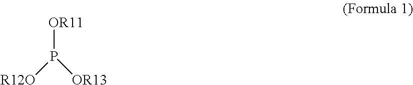

where each of R11, R12, and R13 is independently a monovalent hydrocarbon group or a monovalent fluorinated hydrocarbon group.

The hydrocarbon group, which is a general term of a group constituted by C and H, may be linear, branched by including one, two, or more than two side chains, or annular. The hydrocarbon group may also include an unsaturated bond. The monovalent hydrocarbon group includes an alkyl group having a range of one to five carbon numbers, for example. The fluorinated hydrocarbon group is a group obtained from the aforementioned hydrocarbon group where at least a part of hydrogen groups (—H) is displaced by fluorine groups (—F). The monovalent hydrocarbon group has a range of one to five carbon numbers such as —CF₃, —C₂F₅, and —CH₂CF₃, for example.

The electrolyte including the phosphite ester compound represented by the formula 1 restrains LiPF₆ from being resolved at high temperature. The electrolyte (non-aqueous solvent) is restrained from being resolved and thus from being deteriorated at high temperature. In a state where the aforementioned electrolyte is used in an energy storage device, the device is restrained from being deteriorated at high temperature, i.e., an internal resistance of the device is restrained from increasing at high temperature.

Additionally, in a case where LiPF₆ is used as the electrolyte salt in the electrolyte for the energy storage device, for example, LiPF₆ reacts with a specific functional group (a phenolic hydroxyl group (—OH) and/or a carboxyl group (—COOH), for example) arranged at the surface of carbon material (for example, activated carbon) forming each positive electrode of the energy storage device at high temperature. This causes PF₆⁻ in LiPF₆ to be resolved and consumed. The resolution of PF₆⁻ also causes the non-aqueous solvent included in the electrolyte to be resolved, which may deteriorate the energy storage device at high temperature.

In a case where the electrolyte including the phosphite ester compound represented by the formula 1 is used for the energy storage device, the specific functional group (i.e., a specific acid functional group such as a phenolic hydroxyl group (—OH) and a carboxyl group (—COOH), for example) existing at the surface of carbon material such as activated carbon forming the positive electrode of the energy storage device is capped, i.e., converted, with a group included in the phosphite ester compound represented by the formula 1 (i.e., the group —O—R1 (R2, R3)). Specifically, the phenolic hydroxyl group (—OH) is converted into “—O—R1 (R2, R3)” with “—O—R1 (R2, R3)” included in the phosphite ester compound represented by the formula 1, for example. Additionally, the carboxyl group (—COOH) is converted into “—O—R1 (R2, R3)” with “—O—R1 (R2, R3)” included in the phosphite ester compound represented by the formula 1, for example. The reaction of the specific functional group (the carboxyl group (—COOH) and the phenolic hydroxyl group (—OH)) with LiPF₆ may be inhibited to restrain resolution of LiPF₆, which also restrains resolution of the non-aqueous solvent included in the electrolyte and deterioration of the electrolyte at high temperature.

Specific examples of the phosphite ester compound represented by the formula 1 are, for example, tris(2,2,2-trifluoroethyl) phosphite that is a compound represented by a formula 1-1, tris(1,1,1,3,3,3-hexafluoro-propyl) phosphite, that is a compound represented by a formula 1-2, and phosphite ester (for example, trimethyl phosphite, triethyl phosphite, and tripropyl phosphite). One, two, or more than two types of phosphite ester compound represented by the formula 1 may be included in the electrolyte.

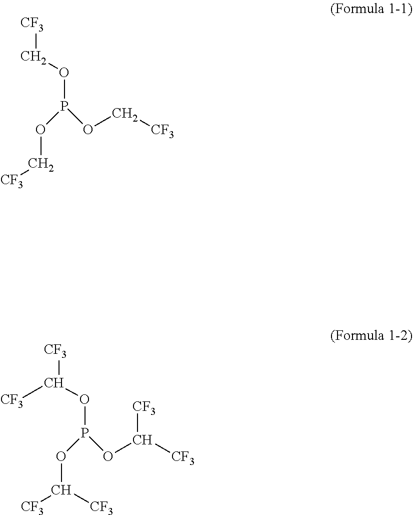 [SMILES: FC(F)(F)COP(OCC(F)(F)F)OCC(F)(F)F ; FC(F)(F)C(OP(OC(C(F)(F)F)C(F)(F)F)OC(C(F)(F)F)C(F)(F)F)C(F)(F)F]

The content of the phosphite ester compound represented by the formula 1 is desirably equal to or greater than 0.1 wt % relative to the content of the non-aqueous solvent and the electrolyte salt in the electrolyte, and is further desirably equal to or greater than 3 wt % in view of restraining the deterioration of the electrolyte at high temperature. The upper limit of the content of the phosphite ester compound represented by the formula 1, if specified, is desirably equal to or smaller than 20 wt % of the content of the non-aqueous solvent and the electrolyte salt in the electrolyte.

In view of further restraining the deterioration at higher temperature, the electrolyte desirably includes, in addition to the phosphite ester compound represented by the formula 1, at least one component selected from a compound that is able to form lithium and complex and including a formation constant for forming lithium complex (which may be referred to as a complex formation constant or K) being equal to or greater than 10², which is hereinafter referred to as a lithium complex formation compound, for convenience, difluorophosphate represented by a formula 2, and a phosphate ester compound represented by a formula 3. In this case, the content of the phosphite ester compound represented by the formula 1 is also desirably within the aforementioned content range.

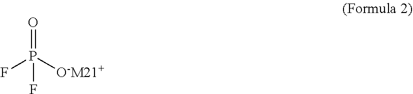

where M21⁺ is lithium ion (Li⁺) or sodium ion (Na⁺).

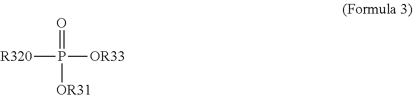

where each of R31, R32, and R33 is independently a monovalent hydrocarbon group or a monovalent fluorinated hydrocarbon group.

The electrolyte includes at least one of the lithium complex-forming compound, the difluorophosphate represented by the formula 2, and the phosphate ester compound represented by the formula 3 in addition to the phosphite ester compound represented by the formula 1. Thus, deterioration at high temperature, specifically, deterioration of the electrolyte and the energy device at high temperature, is further restrained. Specifically, the deterioration at high temperature is further restrained by the effect of the phosphite ester compound represented by the formula 1 for restraining the resolution of LiPF₆, the effect being enhanced by the aforementioned compound(s) included in the electrolyte together with the phosphite ester compound, and/or by the effect of addition of such compound(s).

In view of restraining the deterioration at high temperature, the electrolyte desirably includes one of the aforementioned three compounds, further desirably includes two of the aforementioned three compounds, and highly desirably includes three of the aforementioned three compounds included in the electrolyte together with the phosphite ester compound represented by the formula 1.

Specific examples of the lithium complex-forming compound are crown ether and azacrown ether, for example. Specific examples of crown ether are 15-crown-5 (log K=4.2, i.e., K=10^{4.2}, refer to Bulletin of the chemical society of Japan 1988, 61(3), 627-632), and 12-crown-4 (log K=2.81, i.e., K=10^{2.81}, refer to Journal of physical chemistry, 1996, 100(34), 14485-14491). Specific examples of azacrown ether are benzyl-1-aza-12-crown-4 (log K=4.32, i.e., K=10^{4.32}, refer to Journal of physical chemistry, 1996, 100(34), 14485-14491), for example. The electrolyte may include one, two, or more than two types of lithium complex-forming compound.

The content of the lithium complex-forming compound in the electrolyte is desirably in a range between 1 wt % and 5 wt %, inclusive, relative to the content of the non-aqueous solvent and the electrolyte salt in view of further restraining the deterioration at higher temperature.

Specific examples of the difluorophosphate represented by the formula 2 are lithium difluorophosphate (LiPO₂F₂) and sodium difluorophosphate (NaPO₂F₂), for example. The electrolyte may include one, two, or more than two types of difluorophosphate represented by the formula 2.

The content of the difluorophosphate represented by the formula 2 in the electrolyte is desirably equal to or greater than 0.1 wt % relative to the content of the non-aqueous solvent and the electrolyte salt in view of restraining the deterioration at higher temperature.

A specific example of the phosphate ester compound represented by the formula 3 is tris(2,2,2-trifluoroethyl) phosphate that is a compound represented by a formula 3-1, for example. The electrolyte may include one, two, or more than two types of phosphate ester compound represented by the formula 3.

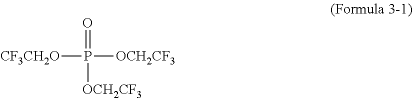

The content of the phosphate ester compound represented by the formula 3 in the electrolyte is desirably in a range between 1 wt % and 5 wt %, inclusive relative to the content of the non-aqueous solvent and the electrolyte salt in view of further restraining the deterioration at higher temperature.

The electrolyte according to the first embodiment when being used at the energy storage device restrains the energy storage device from deteriorating at high temperature, i.e., restrains the internal resistance of the energy storage device from increasing at high temperature.

An energy storage device according to a second embodiment is explained with reference to the attached drawings. The energy storage device according to the second embodiment is an electrochemical capacitor, specifically, a lithium ion capacitor. In the disclosure, capability of adsorption and desorption means capability of reversible occlusion (storing or insertion) and detachment (release).

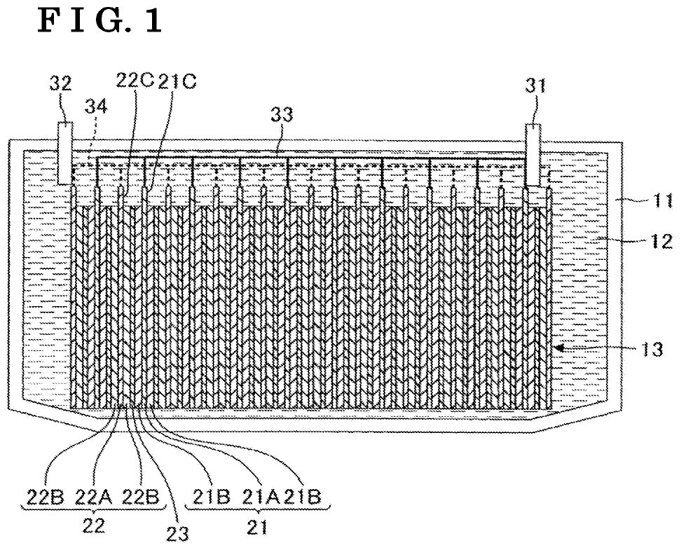

As illustrated in FIG. 1, the energy storage device includes an external body 11 having an inner void, an electrolyte 12 housed within the external body 11, and a laminated body 13 impregnated or immersed in the electrolyte 12. The external body 11 is constituted by laminated film in a pouch form where aluminum film and polypropylene film are laminated, for example.

As illustrated in FIG. 1, each positive electrode 21 includes a positive electrode collector 21A having a rectangular plane form and positive electrode active material layers 21B, 21B laminated on opposed main surfaces of the positive electrode collector 21A. The positive electrode active material layers 21B, 21B are formed on the positive electrode collector 21A so that the positive electrode collector 21A is partially exposed. Such exposed portion, i.e., an exposed portion 21C, of the positive electrode collector 21A functions as a terminal from which electric current is taken to the outside. The exposed portion 21C is electrically connected to a positive terminal tab 31 through a conductive connection member 33. The positive terminal tab 31 functions as a positive electrode terminal of the electrochemical capacitor.

The positive electrode collector 21A is made from a material including appropriate conductivity (good conductor). In the present embodiment, the positive electrode collector 21A is made from aluminum foil, for example.

The positive electrode active material layer 21B includes a positive electrode active material. The positive electrode active material layer 21B may include at least one of binder and conductive assistant (additive) such as acetylene black, ketjen black, and carbon nanotube (CNT), for example.

The positive electrode active material is constituted by material (specifically, positive electrode material) that is able to adsorb and desorb (reversibly occlude or store, and detach or release) electrolyte salt anion. The positive electrode active material may be constituted by carbon material such as carbon nanotube and activated carbon, for example. One type or mixture of two or more than two types of positive electrode active material may be employed.

The carbon material used for the positive electrode active material desirably includes 8 mol % (mole percentage) or more of lactone groups (which may be hereinafter simply referred to as a lactone group ratio) arranged at the surface of the carbon material relative to the total amount of functional groups, i.e., acid functional groups, arranged at the surface of the carbon material. The lactone group ratio is obtainable by Bohem method.

As illustrated in FIG. 1, each negative electrode 22 includes a negative electrode collector 22A having a rectangular plane form and negative electrode active material layers 22B, 22B laminated on opposed main surfaces of the negative electrode collector 22A. The negative electrode active material layers 22B, 22B is formed on the negative electrode collector 22A so that the negative electrode collector 22A is partially exposed. Such exposed portion, i.e., an exposed portion 22C, of the negative electrode collector 22A functions as a terminal from which electric current is taken to the outside. The exposed portion 22C is electrically connected to a negative terminal tab 32 through a conductive connection member 34. The negative terminal tab 32 functions as a negative electrode terminal of the electrochemical capacitor.

The negative electrode collector 22A is made from a material including appropriate conductivity (good conductor). In the present embodiment, the negative electrode collector 22A is made from copper foil, for example.

The negative electrode active material layer 22B, which includes a negative electrode active material, includes a carbon material that is able to adsorb and desorb (i.e., reversibly occlude/store and detach/release) lithium ion, and includes at least one of binder such as styrene-butadiene rubber (SBR), for example, and conductive assistant (additive). At least one of binder and conductive assistant (additive) may be omitted. The carbon material may be graphite (black lead) or carbon nanotube, for example. One type or mixture of two or more than two types of negative electrode active material may be employed.

Separators 23 are constituted by insulating porous membranes provided to inhibit short circuit between the positive electrodes 21 and the negative electrodes 22. Each separator 23 may be made of polyethylene, polypropylene, or any other insulating porous film, or of nonwoven fabric, for example. The porous film may be constituted by one type of high polymer compound, or two or more than two types of high polymer compound. A laminated separator where two or more than two types of high polymer compound layers (membranes) (for example, high polymer films) are laminated in a thickness direction thereof is an example of the porous film constituted by two or more than two types of high polymer compound. Such laminated separator is a porous film where a polypropylene layer, a polyethylene layer, and a polypropylene layer are laminated in this order, for example.

The electrolyte 12 provided for the energy storage device according to the second embodiment is constituted by the electrolyte of the first embodiment. “The amount (mol) of phosphite ester compound contained in the electrolyte 12 and represented by the formula 1” and “the amount (mol) of functional groups defined by the total amount of phenolic hydroxyl groups and carboxyl groups existing at carbon material for the positive electrode” desirably satisfy a relational expression 1 as below:

[The amount (mol) of phosphite ester compound contained in the electrolyte 12 and represented by the formula 1]=a1×[the amount (mol) of functional groups defined by the total amount (i.e., the sum of the amounts) of phenolic hydroxyl groups and carboxyl groups existing at carbon material for the positive electrode]

where a coefficient a1 is equal to or greater than 1.67.

“The amount (mol) of functional groups defined by the total amount of phenolic hydroxyl groups and carboxyl groups existing at carbon material for the positive electrode (i.e., the amount (mol) of acid functional groups excluding lactone groups)” is obtained as follows. First, “the amount (mol/g) of functional groups other than lactone groups per unit mass on the surface of the positive electrode active material” is obtained by Bohem method. The functional groups other than the lactone groups correspond to phenolic hydroxyl groups (—OH) and carboxyl groups (—COOH). “The amount (mol/g) of functional groups other than the lactone groups per unit mass at the positive electrode active material” is multiplied by “the amount (g) of positive electrode active material included in cells (positive electrodes)” to obtain “the amount (mol) of functional groups defined by the total amount of phenolic hydroxyl groups and carboxyl groups existing at carbon material for the positive electrode”.

In a case where the energy storage device satisfies the aforementioned relational expression 1, “the specific functional groups other than the lactone groups on the surface of the positive electrode active material (i.e., phenolic hydroxyl groups (—OH) and carboxyl groups (—COOH))” may be sufficiently capped with the phosphite ester compound represented by the formula 1 in the electrolyte 12. The deterioration at high temperature, specifically, the deterioration of the electrolyte 12 and the energy storage device at high temperature, is further restrained in a state where the energy storage device satisfies the relational expression 1.

The aforementioned energy storage device (lithium ion capacitor) includes the negative electrodes 22 where charge and discharge of electrical energy is achieved by electrochemical reaction of lithium (i.e., faradaic reaction) and the positive electrodes 21 where charge and discharge of electrical energy is achieved by adsorption and desorption of electrolyte salt anion.

In a case where a predetermined voltage is applied to between each positive electrode collector 21A and each negative electrode collector 22A of the aforementioned energy storage device (lithium ion capacitor), electrolyte salt anion in the electrolyte 12 is adsorbed (occluded) at the positive electrode 21. In addition, lithium ion is adsorbed (occluded) at the negative electrode 22. The energy storage device (lithium ion capacitor) is thus charged.

In a case where an electric load (electric resistance) is connected between each positive electrode collector 21A and each negative electrode collector 22A of the aforementioned energy storage device (lithium ion capacitor), the electrolyte salt anion in the electrolyte 12 is released from the positive electrode active material into the electrolyte 12. In addition, the lithium ion is released from the negative electrode 22 (carbon material) into the electrolyte 12. The energy storage device (lithium ion capacitor) is thus discharged.

The aforementioned energy storage device is manufactured as below, for example.

A positive electrode active material and, as necessary, conductive assistant (additive) and binder (for example, acryl resin) are mixed in aqueous solution where carboxymethyl cellulose (CMC) is dispersed to prepare a slurry solution of positive electrode mixture (positive electrode mixture slurry). The positive electrode mixture slurry is then applied to a rectangular area of the positive electrode collector 21A except for the exposed portion 21C.

The positive electrode mixture slurry is dried to remove water therefrom and is then rolled by a roll press, for example, to manufacture the positive electrode collector 21A including the exposed portion 21C that is not applied with the positive electrode mixture slurry and that serves as a positive electrode terminal, and the positive electrode active material layers 21B, i.e., to manufacture the positive electrode 21.

A negative electrode active material and, as necessary, conductive assistant (additive) and binder (for example, SBR) are mixed in aqueous solution where carboxymethyl cellulose (CMC) is dispersed to prepare a slurry solution of negative electrode mixture (negative electrode mixture slurry).

The negative electrode mixture slurry is applied to a respective rectangular area of the negative electrode collector 22A except for the exposed portion 22C.

The negative electrode mixture slurry is dried to remove water therefrom and is then rolled by a roll press, for example, to manufacture the negative electrode collector 22A including the exposed portion 22C that is not applied with the negative electrode mixture slurry and that serves as a negative electrode terminal, and the negative electrode active material layers 22B, i.e., to manufacture the negative electrode 22.

Next, an electrolyte salt is dissolved in non-aqueous solvent to which the aforementioned compound(s) is further added to prepare the electrolyte 12. The electrolyte according to the first embodiment is employed for the electrolyte 12.

The plural positive electrodes 21, the plural negative electrodes 22, and the plural separators 23 constitute the laminated body 13 in a manner that the negative electrode 22, the separator 23, the positive electrode 21, and the separator 23 are laminated in the mentioned order repeatedly as illustrated in FIG. 1.

The laminated body 13 is placed into the external body 11 constituted by aluminum laminated film into which the electrolyte 12 is then injected, so that the laminated body 13 is immersed in the electrolyte 12. The external body 11 is closed and sealed so that the energy storage device is completed. An aging process that is explained later may be thereafter performed on the energy storage device.

The energy storage device according to the second embodiment is restrained from being deteriorated at high temperature, i.e., the internal resistance of the energy storage device is restrained from increasing at high temperature.

Next, a manufacturing method of an energy storage device according to a third embodiment is explained. In order to easily understand the manufacturing method, a summary thereof is first explained as follows.

In the energy storage device (i.e., a lithium ion capacitor or a lithium ion secondary battery, for example) utilizing lithium adsorption and desorption reaction at the negative electrodes that include graphite (black lead), for example, a negative electrode potential decreases and a reducing power of each negative electrode increases. This may cause reductive decomposition of the electrolyte especially at high temperature. On the other hand, solid electrolyte interphase (SEI) layer formed at the negative electrode restrains reductive decomposition of the electrolyte. If thermal stability of the SEI layer (film) at high temperature is low, the SEI layer is degraded or altered, which may reduce an effect to restrain reductive decomposition of the electrolyte. The energy storage device may be deteriorated at high temperature. The SEI layer thus needs to be thermally stabilized at high temperature.

In the manufacturing method of the energy storage device according to the third embodiment, an aging process is performed on the energy storage device after it is assembled. The SEI layer formed at the negative electrode is thus appropriately reformed. Surface deposition of lithium occluded and adsorbed at the negative electrode active material at high temperature is restrained to improve thermal stability of the SEI layer at high temperature. The energy storage device that is restrained from being deteriorated at high temperature is thus manufactured.

Details of the manufacturing method of the energy storage device according to the third embodiment are explained below.

In the third embodiment, the energy storage device is assembled in the similar manner to that explained as the example of the manufacturing method according to the second embodiment. At this time, the electrolyte 12 explained in the first embodiment is utilized.

Next, the aging process is performed on the assembled energy storage device.

Specifically, the assembled energy storage device is applied with voltage using a charge/discharge device and is left for a predetermined time period depending on the magnitude and state of the applied voltage under temperature environment in a range between 80° C. and 120° C., inclusive.

Specifically, the assembled energy storage device is disposed in a constant-temperature bath that is specified at a constant temperature chosen from the range between 80° C. and 120° C., for example. The energy storage device is left in the bath for the predetermined time period in a state of continuously charging and discharging (i.e., performing seamless charge and discharge). Such charging and discharging of the energy storage device is conducted with an upper limit voltage selected from among voltages corresponding to a first SOC range where a state of charge (SOC) of the energy storage device is specified between 50% and 100% (for example, 3.8V) and a lower limit voltage selected from among voltages corresponding to a second SOC range where the SOC of the energy storage device is specified between 0% and 20% (for example, 2.2V). That is, charging and discharging of the energy storage device is performed between the first SOC range and the second SOC range. The energy storage device is thus completed.

The aging process causes the SEI layer formed at the negative electrode 22 to be appropriately reformed. The energy storage device that is further restrained from being deteriorated at high temperature is manufactured.

The predetermined time period during which the aging process is performed, i.e., during which the energy storage device is left in the constant-temperature bath, is desirably in a range between 5 hours and 17 hours, inclusive. With the predetermined time period less than 5 hours, the SEI layer is only slightly reformed, so that an effect obtained by the reformation of the SEI layer for restraining the deterioration of the energy storage device at high temperature may decrease. On the other hand, with the predetermined time period more than 17 hours, the SEI layer is excessively reformed, so that the effect obtained by the reformation of the SEI layer for restraining the deterioration of the energy storage device at high temperature may also decrease.

According to the manufacturing method of the energy storage device of the third embodiment, the SEI layer formed at the surface of the negative electrode 22 is appropriately reformed (for example, densified) by the aging process. Additionally, the electrolyte employed in the first embodiment is utilized as the electrolyte 12 for manufacturing the energy storage device. The energy storage device that restrains its deterioration at high temperature is thus manufactured.

The aging process in the manufacturing method of the energy storage device according to the third embodiment may be performed as follows. Such modified example obtains the same effect as that of the third embodiment.

Specifically, the assembled energy storage device is disposed in a constant-temperature bath that is specified at a constant temperature chosen from a range between 80° C. and 120° C. The assembled energy storage device disposed in the constant-temperature bath is then applied with voltage and is left for a predetermined time period while the applied voltage is maintained at a voltage level selected from among voltages corresponding to a first SOC range where the SOC of the energy storage device is specified between 50% and 100% (for example, 3.0V as a constant voltage). The energy storage device is thus completed.

The aforementioned predetermined time period is desirably in a range between 50 hours and 153 hours. With the predetermined time period less than 50 hours, the SEI layer is only slightly reformed, so that the effect obtained by the reformation of the SEI layer for restraining the deterioration of the energy storage device at high temperature may decrease. On the other hand, with the predetermined time period more than 153 hours, the SEI layer is excessively reformed, so that the effect obtained by the reformation of the SEI layer for restraining the deterioration of the energy storage device at high temperature may also decrease.

Examples of the aforementioned embodiments are explained as below. The embodiments are not limited to such examples.

Ethylene carbonate (EC), propylene carbonate (PC), and ethyl methyl carbonate (EMC) serving as non-aqueous solvent are mixed in a state where a volume ratio of EC, PC, and EMC is 2:2:7 to prepare a mixed solvent.

Next, LiPF₆ serving as an electrolyte salt is resolved in the aforementioned mixed solvent so that the concentration of the electrolyte salt is equal to 1.0 mol/L to thereby prepare an electrolyte. Tris(2,2,2-trifluoroethyl) phosphite that is a compound (specifically, a phosphite ester compound) represented by the formula 1-1 is added to the aforementioned electrolyte so that the content of the compound in the electrolyte is equal to 3 wt %. In this case, a unit of the content of the compound represented by the formula 1-1 in the electrolyte, i.e., the unit “wt %”, is a mass percentage to a total mass of the mixed solvent and the electrolyte salt. The electrolyte according to Example 1-1 is thus prepared.

Examples 1-2, 1-3, and 1-4 of electrolyte are prepared in the similar manner to Example 1-1 except that the content of the compound represented by the formula 1-1 is changed as in Table 1 below.

Comparison 1-1 of electrolyte is prepared in the similar manner to Example 1-1 except that the compound represented by the formula 1-1 is not added.

Examples 2-1, 2-2, and 2-3 of electrolyte are prepared in the similar manner to Example 1-1 except that, in addition to the compound represented by the formula 1-1, one compound in Table 1 is further added while preparing the electrolyte so that the content of such compound in the electrolyte is equal to each value in Table 1.

Comparisons 2-1 to 2-11 of electrolyte are prepared in the similar manner to Example 1 except that, instead of the compound represented by the formula 1-1, one compound in Table 1 is added while preparing the electrolyte so that the content of such compound in the electrolyte is equal to each value in Table 1.

Comparisons 2-12 to 2-14 of electrolyte are prepared in the similar manner to Example 1 except that, instead of the compound represented by the formula 1-1, two compounds in Table 1 are added while preparing the electrolyte so that the contents of such compounds in the electrolyte are equal to values in Table 1.

Examples 3-1 to 3-3 of electrolyte are prepared in the similar manner to Example 1 except that, in addition to the compound represented by the formula 1-1, two compounds in Table 1 are further added while preparing the electrolyte so that the contents of such compounds in the electrolyte are equal to values in Table 1.

Comparison 3-1 of electrolyte is prepared in the similar manner to Example 1 except that, instead of the compound represented by the formula 1-1, three compounds in Table 1 are added while preparing the electrolyte so that the contents of such compounds in the electrolyte are equal to values in Table 1.

Example 4-1 of electrolyte is prepared in the similar manner to Example 1 except that, in addition to the compound represented by the formula 1-1, three compounds in Table 1 are further added while preparing the electrolyte so that the contents of such compounds in the electrolyte are equal to values in Table 1.

Each electrolyte prepared in the aforementioned manner is evaluated for high-temperature degradation. Specifically, a high-temperature degradation evaluation (high-temperature gas generation evaluation) is performed on each electrolyte as follows.

50 ml of the aforementioned each electrolyte is injected into an experimental pouch cell that is then sealed. The sealed pouch cell is stored in a constant-temperature bath at approximately 100° C. A difference between the volume of the pouch cell after a predetermined time (for example, 200 hours) has elapsed (i.e., a volume V1) and the volume of the pouch cell before the pouch cell is stored in the bath (i.e., a volume V0) (i.e., a difference V1−V0) is measured as the amount of gas generation. The volume of the pouch cell is measured with Archimedes method. The amount of gas generation (μL) is divided by the predetermined time (h) to measure a rate of gas generation (μL/h). Measured results are shown in Table 1.

TABLE 1

| | Additive | | | | | | | | Evaluation |
|---|---|---|---|---|---|---|---|---|---|
| | Phosphite ester | | | | | | Phosphate ester | | Gas |
| | compound | | Crown ether | | Difluorophosphate | | compound | | generation |
| | | Content | | Content | | Content | | Content | rate |
| | Type | (wt %) | Type | (wt %) | Type | (wt %) | Type | (wt %) | [μL/h] |
| Example 1-1 | Formula | 3 | — | — | — | — | — | — | 14 |
| Example 1-2 | 1-1 | 6 | — | — | — | — | — | — | 10 |
| Example 1-3 | | 9 | — | — | — | — | — | — | 3 |
| Example 1-4 | | 12 | — | — | — | — | — | — | 0.6 |
| Comparison 1-1 | — | — | — | — | — | — | — | — | 226 |
| Example 2-1 | Formula | 3 | 15-crown-5 | 3 | — | — | — | — | 5 |
| Example 2-2 | 1-1 | | — | — | Lithium | 0.5 | — | — | 1 |
| | | | | | difluorophosphate | | | | |
| Example 2-3 | | | — | — | — | — | Formula | 3 | 2 |
| | | | | | | | 3-1 | | |
| | — | — | 15-crown-5 | 3 | — | — | — | — | 1023 |
| Comparison 2-2 | — | — | | 6 | — | — | — | — | 909 |
| Comparison 2-3 | — | — | | 9 | — | — | — | — | 317 |
| Comparison 2-4 | — | — | | 12 | — | — | — | — | 97 |
| Comparison 2-5 | — | — | — | — | Lithium | 0.1 | | — | 196 |
| Comparison 2-6 | — | — | — | — | difluorophosphate | 0.5 | | — | 64 |
| Comparison 2-7 | — | — | — | — | | 1 | | — | 538 |
| Comparison 2-8 | — | — | — | — | — | — | Formula | 3 | 33 |
| Comparison 2-9 | — | — | — | — | — | — | 3-1 | 6 | 380 |
| Comparison 2-10 | — | — | — | — | — | — | | 9 | 377 |
| Comparison 2-11 | — | — | — | — | — | — | | 12 | 388 |
| Comparison 2-12 | — | — | 15-crown-5 | 3 | Lithium | 0.5 | — | — | 1046 |
| | | | | | difluorophosphate | | | | |
| Comparison 2-13 | — | — | 15-crown-5 | 3 | — | — | Formula | 0.3 | 736 |
| | | | | | | | 3-1 | | |
| Comparison 2-14 | — | — | — | — | Lithium | 0.5 | Formula | 3 | 66 |
| | | | | | difluorophosphate | | 3-1 | | |
| Example 3-1 | Formula | 3 | 15-crown-5 | 3 | Lithium | 0.5 | — | — | 1 |
| | 1-1 | | | | difluorophosphate | | | | |
| Example 3-2 | Formula | 3 | — | — | Lithium | 0.5 | Formula | 3 | 3 |
| | 1-1 | | | | difluorophosphate | | 3-1 | | |
| Example 3-3 | Formula | 3 | 15-crown-5 | 3 | — | — | Formula | 3 | 2 |
| | 1-1 | | | | | | 3-1 | | |
| Comparison 3-1 | — | — | 15-crown-5 | 3 | Lithium | 0.5 | Formula | 3 | 225 |
| | | | | | difluorophosphate | | 3-1 | | |
| Example 4-1 | Formula | 3 | 15-crown-5 | 3 | Lithium | 0.5 | Formula | 3 | 0 |
| | 1-1 | | | | difluorophosphate | | 3-1 | | |

As shown in Table 1, the rate of gas generation of each of Examples 1-1 to 1-4 is smaller than that of Comparison 1-1. It is thus confirmed that the electrolyte including the compound represented by the formula 1 is restrained from being resolved (degraded) at high temperature. According to Examples 2-1 to 2-3, 3-1 to 3-3, and 4-1, it is also confirmed that the electrolyte including two or more than two compounds that include at least the compound represented by the formula 1, from among the compound represented by the formula 1, 15-crown-5, lithium difluorophosphate, and the phosphate ester compound represented by the formula 3-1, is restrained from being resolved (degraded) at high temperature. This is because a phosphite ester compound, a phosphate ester compound, crown ether, and difluorophosphate have a function to restrain PF₅ in LiPF₆ as the electrolyte salt from generating or to restrain generated PF₅ from resolving. In a case where a phosphite ester compound and other additive(s) are mixed together, their mutual interaction enhances the function of the phosphite ester compound to restrain PF₅ in LiPF₆ from generating or to restrain generated PF₅ from resolving.

An evaluation cell (lithium ion capacitor) for Example 5-1 is prepared as below. The mole percentage of the amount of lactone groups existing at the surface of activated carbon relative to the total amount of functional groups (acid functional groups) at the surface of the activated carbon used as the positive electrode active material, i.e., a lactone group ratio, is measured as follows.

The amount of lactone groups arranged at the surface of the activated carbon is measured by Bohem method. Specifically, a sodium hydroxide solution (concentration of 0.05 mol/L), a sodium hydrogen carbonate solution (concentration of 0.1 mol/L), and a sodium carbonate solution (concentration of 0.05 mol/L) are prepared as an alkali solution.

0.5 g of activated carbon is added to 80 ml of the prepared sodium hydroxide solution, so that ultrasonic dispersion is performed on the solution. Such solution, specifically, the sodium hydroxide solution to which the activated carbon is added, is stirred for 18 hours. Then, the sodium hydroxide solution including the activated carbon (80 ml) is filtered to obtain 20 ml of filtrate. Back titration is performed on 20 ml of the filtrate with an HCl solution (concentration of 0.1 mol/L). The amount of functional groups (all the acid functional groups, i.e., the total amount of carboxyl groups, lactone groups, and phenolic hydroxyl groups) arranged at the surface of the activated carbon is calculated on a basis of the titration value of HCl (i.e., X [ml]) using a calculation formula 1.

[Total amount of functional groups (mmol/g)]={[(20 ml×b (mmol/ml)×fb)−(X (ml)×a (mmol/ml)×fa)]×(80/20)}÷S (g) Calculation formula 1:

where “a (mmol/ml)” is the concentration of the HCl solution, “fa” is a factor of the HCl solution, “b (mmol/ml)” is the concentration of the alkali solution, “fb” is a factor of the alkali solution, “X (ml)” is the titration value of the HCl solution, and “S (g)” is the amount of the activated carbon (positive electrode active material).

Additionally, back titration is performed on the HCl solution in the same manner as above with the exception that the sodium hydrogen carbonate solution is used instead of the sodium hydroxide solution. The amount of functional groups (i.e., carboxyl groups) existing at the surface of the activated carbon is calculated on a basis of the titration value of HCl using the calculation formula 1.

Further, back titration is performed on the HCl solution in the same manner as above with the exception that the sodium carbonate solution is used instead of the sodium hydroxide solution. The amount of functional groups (i.e., the total amount of carboxyl groups and lactone groups) arranged at the surface of the activated carbon is calculated on a basis of the titration value of HCl using the calculation formula 1.

The amount of carboxyl groups and the amount of lactone groups are subtracted from the total amount of acid functional groups (i.e., carboxyl groups, lactone groups, and phenolic hydroxyl groups) to calculate the amount of phenolic hydroxyl groups. Additionally, the amount of carboxyl groups and the amount of phenolic hydroxyl groups are subtracted from the total amount of acid functional groups (i.e., carboxyl groups, lactone groups, and phenolic hydroxyl groups) to calculate the amount of lactone groups arranged at the surface of the activated carbon (i.e., [the amount of carboxyl groups, the amount of lactone groups, and the amount of phenolic hydroxyl groups]−[the amount of carboxyl groups and the amount of phenolic hydroxyl groups]).

The mole percentage (mol %) of the amount of lactone groups arranged at the surface of activated carbon relative to the total amount of functional groups (acid functional groups) at the surface of the activated carbon is calculated as follows:

[(The calculated amount of lactone groups arranged at the surface of activated carbon)÷(the total amount of acid functions groups)]×100 (mol %)

A slurry solution of a positive electrode mixture (positive electrode mixture slurry) is prepared by mixing activated carbon (8 mol % of lactone group ratio) serving as the positive electrode active material, acetylene black (LB-400 manufactured by Denka Company Limited) serving as conductive assistant (additive), and an aquatic binder (TRD202A manufactured by JSR Corporation) serving as binder into a solution where carboxymethyl cellulose (CMC) (manufactured by Daicel FineChem Ltd.) is dispersed. A compound ratio is adjusted so that 90 wt % of activated carbon, 5 wt % of acetylene black, 2 wt % of CMC, and 3 wt % of aquatic binder are satisfied.

The positive electrode mixture slurry prepared in the aforementioned manner is applied to opposed sides (specifically, to a rectangular area except for an exposed portion) of aluminum foil (i.e., a porous structure).

The aforementioned aluminum foil is then dried to remove water from the positive electrode mixture slurry to obtain the aluminum foil including a positive electrode active material layer where the exposed portion (that is not applied with the positive electrode mixture slurry) serves as the positive terminal, i.e., to obtain the positive electrode.

A slurry solution of a negative electrode mixture (negative electrode mixture slurry) is prepared by mixing graphite (black lead) serving as the negative electrode active material, acetylene black (LB-400 manufactured by Denka Company Limited) serving as conductive assistant (additive), and an aquatic binder (TRD2001 manufactured by JSR Corporation) serving as binder into a solution where carboxymethyl cellulose (CMC) (manufactured by Daicel FineChem Ltd.) is dispersed. A compound ratio is adjusted so that 94 wt % of graphite, 2 wt % of acetylene black, 2 wt % of CMC, and 2 wt % of aquatic binder are satisfied.

The negative electrode mixture slurry prepared in the aforementioned manner is applied to opposed sides (specifically, to a rectangular area except for an exposed portion) of copper foil (i.e., a porous structure).

The aforementioned copper foil is then dried to remove water from the negative electrode mixture slurry to obtain the copper foil including a negative electrode active material layer where the exposed portion (that is not applied with the negative electrode mixture slurry) serves as the negative terminal, i.e., to obtain the negative electrode.

The electrode prepared as Example 1-1 is employed for Example 5-1.

The negative electrode, a separator made of polyethylene, the positive electrode, and another separator are laminated in the mentioned order repeatedly to obtain a laminated body.

The laminated body is placed into an external body made from aluminum laminated film into which the electrolyte is then injected, so that the laminated body is immersed in the electrolyte. The external body is closed and sealed so that the evaluation cell of Example 5-1 (lithium ion capacitor) is completed. The laminated body is inserted and placed into the external body in a state where a doped electrode constituted by a negative electrode collector (copper foil) and metal lithium foil for pre-doping and the separator are laminated at the outermost layer of the laminated body. The negative electrode and the metal lithium foil are then short-circuited to perform a pre-doping process.

The doped electrode is taken out after the pre-doping process. The evaluation cell of Example 5-1 is thus formed. A ratio (a coefficient a1) of the amount (mol) of phosphite ester compound in the electrolyte, i.e., X1 (=3.3×10⁻³ mol), to the amount (mol) of functional groups defined by the total amount of phenolic hydroxyl groups and carboxyl groups in carbon material of the positive electrode, i.e., X2, is 3.73. That is, a1 (X1/X2)=3.73.

Examples 5-2 to 5-4 of evaluation cell are formed in the similar manner to Example 5-1 except that an activated carbon including lactone group ratio as shown in Table 2 is utilized, instead of the activated carbon used in Example 5-1. Each ratio of the amount (mol) of phosphite ester compound in the electrolyte, i.e., X1 (=3.3×10⁻³ mol), to the amount (mol) of functional groups defined by the total amount of phenolic hydroxyl groups and carboxyl groups in carbon material of the positive electrode, i.e., X2, is a value shown in Table 2.

Comparison 5-1 of evaluation cell is formed in the similar manner to Example 5-1 except that an activated carbon including lactone group ratio as shown in Table 2 is utilized instead of the activated carbon used in Example 5-1. Each ratio of the amount (mol) of phosphite ester compound in the electrolyte, i.e., X1 (=3.3×10⁻³ mol), to the amount (mol) of functional groups defined by the total amount of phenolic hydroxyl groups and carboxyl groups in carbon material of the positive electrode, i.e., X2, is a value shown in Table 2.

Additionally, evaluation cells for comparison (comparison evaluation cells) are formed in the similar manner to Examples 5-1 to 5-4 and Comparison 5-1 except that the electrolyte of Comparison 1-1 (i.e., the electrolyte not including the phosphite ester compound) is utilized for the comparison evaluation cells instead of the electrolyte of Example 1-1.

The evaluation cells formed in the aforementioned manner are evaluated for high-temperature degradation. Specifically, a high-temperature degradation evaluation (durability evaluation) is performed on each evaluation cell as follows.

Each evaluation cell is applied with a high-temperature float charge at 3.8V of float voltage under temperature environment of approximately 100° C. The degree of degradation of the evaluation cell at that time is evaluated on a basis of increase rate of internal resistance (direct-current resistance: DC-IR) of the evaluation cell.

Specifically, the evaluation cell is charged with a constant current charge (CC charge) at 1 A (1 ampere) of constant current under temperature environment of approximately 100° C. until a charge voltage of the evaluation cell reaches 3.8V. The evaluation cell is then switched to be charged with a constant voltage charge (CV charge) at 3.8V of charge voltage.

The DC-IR of the evaluation cell obtained when the voltage of the evaluation cell reaches 3.8V (i.e., at an initial point) is measured by the following method. The DC-IR of the evaluation cell is measured plural times each time a predetermined time (approximately 100 hours) has elapsed, starting from the initial point, by the similar method. Then, measured values are plotted on a coordinate with a horizontal axis indicating an elapsed time from the initial point and a longitudinal axis indicating the DC-IR of the valuation cell to form an approximate curve by linear approximation. Using the aforementioned approximate curve, time from the initial point to a point where the DC-IR of the evaluation cell increases by 50% relative to the DC-IR of the evaluation cell at the initial point (i.e., an endurance time) is calculated.

The evaluation cell is charged with a constant-current and constant-voltage charge (CC-CV charge) at 3.8 V of cut-off voltage and 1 A of constant voltage under temperature environment of approximately 100° C. until an elapsed time from a point where the voltage of the evaluation cell reaches the cut-off voltage satisfies 30 minutes. The evaluation cell is then discharged with a constant current discharge (CC discharge) at 1 A of constant current until the voltage of the evaluation cell reaches 2.2V. A voltage drop ΔV at a point where one second has elapsed from the start of the CC discharge, which is obtained by subtracting the voltage of the evaluation cell when one second has elapsed from the start point of the CC discharge from the voltage of the evaluation cell at the start point of the CC discharge, is then measured and is divided by a current value to measure the DC-IR.

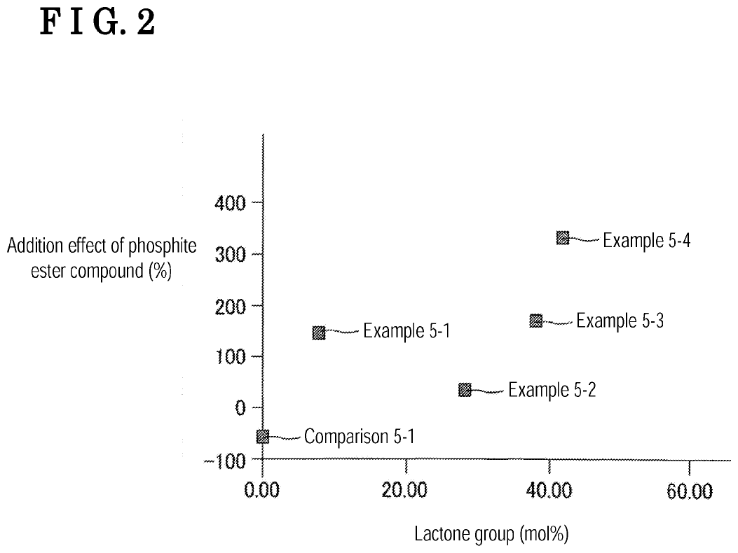

Results of high-temperature degradation evaluation of Examples 5-1 to 5-4, and Comparison 5-1 are shown in Table 2 and FIG. 2. An addition effect (%) of the phosphite ester compound is a value obtained from a calculation formula 2 below. The addition effect (%) of the phosphite ester compound represents an increase rate of the endurance time when the phosphite ester compound is added in a state where the endurance time when the phosphite ester compound is added is specified to be 100.

[Addition effect of phosphite ester compound (%)]=[(time for DC-IR of each Example and Comparison in high-temperature degradation evaluation to increase by 50%)÷(time for DC-IR of each comparison evaluation cell corresponding to Examples and Comparison in high-temperature degradation evaluation to increase by 50%)×100]−100 Calculation formula 2:

TABLE 2

| | Lacton | | Addition effect of |
|---|---|---|---|
| | group ratio | | phosphite ester compound |
| | [mol %] | a1 | (%) |
| Example 5-1 | 8 | 3.73 | 142 |
| Example 5-2 | 28 | 1.67 | 31 |
| Example 5-3 | 38 | 2.28 | 167 |
| Example 5-4 | 42 | 3.22 | 329 |
| Comparison 5-1 | 0 | 1.78 | −58 |

According to Examples 5-1 to 5-4, the lactone group ratio is 8 mol % or more. The addition effect of the phosphite ester compound of Examples 5-1 to 5-4 is thus greater than that of Comparison 5-1 where the lactone group ratio is 0 mol %. This is because lactone groups including less reactivity to the additive and arranged at the surface of the negative electrode active material retains wettability relative to the electrolyte, which restrains increase of the internal resistance of the evaluation cell.

An evaluation cell is formed in the similar manner to Example 5-1. The aging process is then performed on the aforementioned evaluation cell to obtain the evaluation cell (i.e., the evaluation cell on which the aging process has been performed) of Example 6-1. During the aging process, the evaluation cell is left for an hour under temperature environment of approximately 100° C. in a state of continuously charging and discharging (i.e., performing seamless charge and discharge). Specifically, the evaluation cell is charged with a constant current charge (CC charge) at 3.8V of cut-off voltage and 1 A of constant current and is then discharged with a constant current discharge (CC discharge) at 1 A of constant current until the voltage of the evaluation cell reaches 2.2V. After the completion of the aging process, the evaluation cell is degassed (i.e., gas generated in the evaluation cell is removed).

Evaluation cells of Examples 6-2 to 6-5 (specifically, evaluation cells on which the aging process has been performed) are prepared in the similar manner to Example 6-1 except that time during which the evaluation cell is left in the aging process (i.e., aging time) is changed as Table 3.

A different aging process from the aging process performed on the evaluation cell of Example 6-1 is employed for an evaluation cell of Example 7-1 as below. The evaluation cell is left for an hour under temperature environment of approximately 100° C. in a state where the voltage of the evaluation cell is maintained at a constant voltage of 3.0V. Except for the above, the evaluation cell (specifically, the evaluation cell on which the aging process has been performed) of Example 7-1 is prepared in the same manner as Example 6-1.

Evaluation cells (evaluation cells on which the aging process has been performed) of Examples 7-2 to 7-5 are prepared in the same manner as Example 7-1 except that time during which each evaluation cell is left in the aging process (aging time) is changed as Table 3.

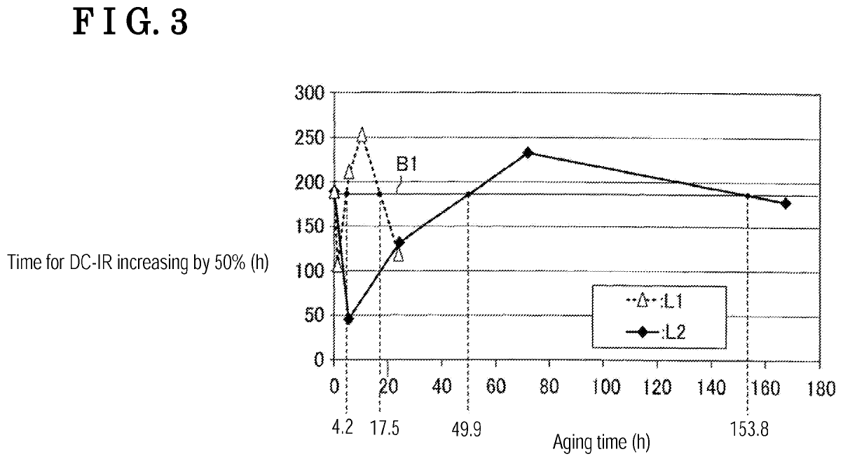

The prepared evaluation cells of Examples 6-1 to 6-5 and 7-1 to 7-5 (i.e., the evaluation cells that are degassed) are evaluated for high-temperature degradation in the aforementioned manner. Results of the high-temperature degradation evaluation (durability evaluation) are shown in Table 3 and FIG. 3.

TABLE 3

| | Aging | | Time for DC-IR to |
|---|---|---|---|
| | time (h) | Applied voltage | increase by 50% [h] |
| Example 6-1 | 1 | Variable | 110 |
| Example 6-2 | 5 | (charge and discharge) | 211 |
| Example 6-3 | 10 | | 253 |
| Example 6-4 | 24 | | 119 |
| Example 6-5 | 0 | | 189 |
| Example 7-1 | 5 | Constant | 47 |
| Example 7-2 | 24 | (constant voltage maintained) | 133 |
| Example 7-3 | 72 | | 234 |
| Example 7-4 | 168 | | 178 |
| Example 7-5 | 0 | | 189 |

As shown in FIG. 3, the evaluation is made with a reference value corresponding to time for DC-IR of Examples 6-5 and 7-5 increasing by 50%. A line B1 in FIG. 3 is the reference line indicating the reference value. Based on the aging time indicated by a crossing point between the line B1 and a line L1 that is obtained by plotting the high-temperature degradation evaluation of the evaluation cells of Examples 6-1 to 6-5, the internal resistance is restrained from increasing as compared to the evaluation cell of Example 6-5 when the aging time is in a range between 5 hours and 17 hours.

Based on the aging time indicated by a crossing point between the line B1 and a line L2 that is obtained by plotting the high-temperature degradation evaluation of the evaluation cells of Examples 7-1 to 7-5, the internal resistance is restrained from increasing as compared to the evaluation cell of Example 7-5 when the aging time is in a range between 50 hours and 153 hours.

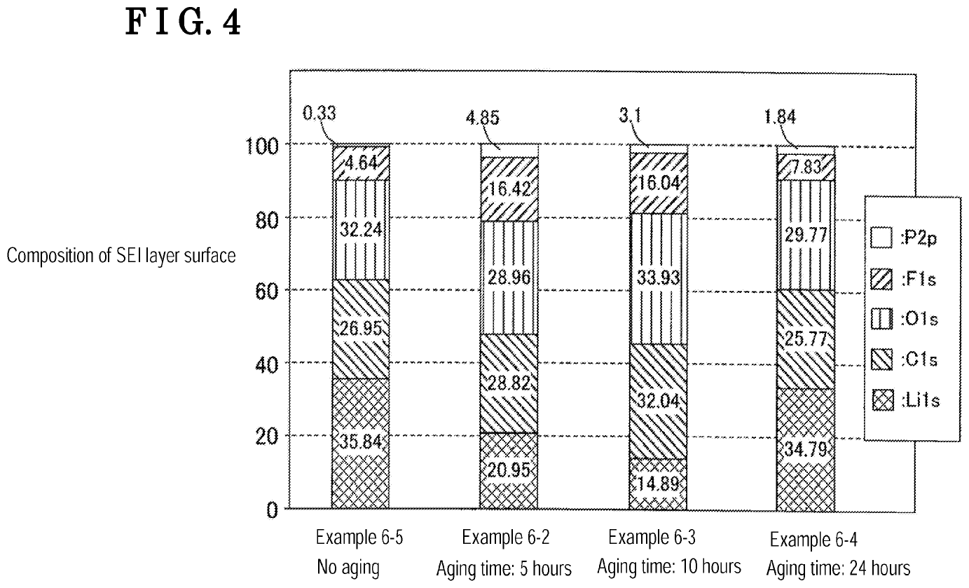

The evaluation cells of Examples 6-2, 6-3, 6-4, and 6-5 are charged with float voltage of 3.8V under temperature environment of approximately 100° C. so that the high-temperature float charge is performed for 1,000 hours. The negative electrode is then taken out to be subjected to X-ray photoemission spectroscopy (XPS) measurement for composition analysis of SEI layer formed at the negative electrode. Results of the analysis are shown in FIG. 4.

As shown in FIG. 4, the lithium ratio of each evaluation cell of Examples 6-2 and 6-3 is smaller than that of Example 6-4 or 6-5. It is thus found that the SEI layer is appropriately reformed at each evaluation cell of Examples 6-2 and 6-3 because of appropriate aging time, as compared to Examples 6-4 and 6-5.

The aforementioned embodiments and examples are appropriately modified and changed.

For example, the constructions, methods, process, configuration, materials, and values of the aforementioned embodiments and examples may be appropriately changed.

Additionally, the constructions, methods, process, configuration, materials, and values of the aforementioned embodiments and examples may be appropriately combined.

The laminated body 13 of the energy storage device may be a wound body where the positive electrode and the negative electrode are laminated via the separator and are wound.

The energy storage device may be different from the aforementioned lithium ion capacitor. For example, the energy storage device may be a lithium ion secondary battery, a dual carbon battery, or any other energy storage devices.

In a case where the energy storage device is a lithium ion secondary battery, for example, the negative electrode active material thereof may be constituted by graphite, hard carbon, soft carbon, carbon nanotube, any other carbon materials that are able to adsorb and desorb lithium ion, or any other materials that are able to adsorb and desorb lithium ion. One type or mixture of two or more than two types of negative electrode active material may be employed.

The positive electrode active material of the lithium ion secondary battery may be achieved by various known materials used for the lithium ion secondary battery, i.e., at least one of lithium cobalt oxide, lithium manganese oxide, lithium nickel dioxide, and any other lithium complex oxide, for example. Such positive electrode active material is able to adsorb and desorb lithium ion.

According to the electrolyte for the energy storage device, the energy storage device, and a manufacturing method of the energy storage device in the disclosure, deterioration thereof at high temperature is restrained.

According to the electrolyte of this disclosure, the content of the phosphite ester compound represented by the formula 1 is desirably equal to or greater than 3 wt %.

In the electrolyte, the content of the phosphite ester compound is in a range from 0.1 wt % to 20 wt %, inclusive, relative to the content of the non-aqueous solvent and the electrolyte salt in the electrolyte.

In the electrolyte, the content of the compound configured to form lithium and a complex and including a formation constant equal to or greater than 10² is in a range from 1 wt % to 5 wt %, inclusive, relative to the content of the non-aqueous solvent and the electrolyte salt in the electrolyte.

In the electrolyte, the content of the difluorophosphate is equal to or greater than 0.1 wt % relative to the content of the non-aqueous solvent and the electrolyte salt in the electrolyte.

In the electrolyte, the content of the phosphate ester compound is in a range from 1 wt % to 5 wt %, inclusive, relative to the content of the non-aqueous solvent and the electrolyte salt in the electrolyte.

According to the energy storage device of this disclosure, a mole percentage of the amount of the lactone group relative to the total amount of the functional groups is equal to or greater than 8 mol %.

The energy storage device is a lithium ion capacitor.

In the energy storage device, the content of the phosphite ester compound is in a range from 0.1 wt % to 20 wt %, inclusive, relative to the content of the non-aqueous solvent and the electrolyte salt in the electrolyte.

In the energy storage device, the content of the compound configured to form lithium and a complex and including a formation constant equal to or greater than 10² is in a range from 1 wt % to 5 wt %, inclusive, relative to the content of the non-aqueous solvent and the electrolyte salt in the electrolyte.

In the energy storage device, the content of the difluorophosphate is equal to or greater than 0.1 wt % relative to the content of the non-aqueous solvent and the electrolyte salt in the electrolyte.

In the energy storage device, the content of the phosphate ester compound is in a range from 1 wt % to 5 wt %, inclusive, relative to the content of the non-aqueous solvent and the electrolyte salt in the electrolyte.

The manufacturing method of the energy storage device of this disclosure includes applying a voltage to the assembled energy storage device while the assembled energy storage device is being left in a manner that charging and discharging are repeatedly performed between a first SOC range where a state of charge of the assembled energy storage device is specified from 50% to 100%, inclusive, and a second SOC range where the state of charge of the assembled energy storage device is specified from 0% to 20%, inclusive.

In the aforementioned manufacturing method, the predetermined time of the aging process is in a range from 5 hours to 17 hours, inclusive.

The manufacturing method includes applying a voltage to the assembled energy storage device while the assembled energy storage device is being left in a manner that the applied voltage is retained at a voltage level selected from among voltages corresponding to a first SOC range where a state of charge of the assembled energy storage device is specified from 50% to 100%, inclusive.

In the aforementioned manufacturing method, the predetermined time of the aging process is in a range from 50 hours to 153 hours, inclusive.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An electrolyte of an energy storage device, the electrolyte comprising:
a non-aqueous solvent;
an electrolyte salt including LiPF₆; and
at least two compounds selected from among a phosphite ester compound represented by a formula 1, a compound configured to form lithium and a complex and including a formation constant equal to or greater than 10² for forming a lithium complex, difluorophosphate represented by a formula 2, and a phosphate ester compound represented by a formula 3, the at least two compounds including at least the phosphite ester compound represented by the formula 1: 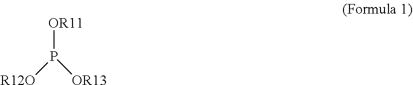
where each of R11, R12, and R13 is independently one of a monovalent hydrocarbon group and a monovalent fluorinated hydrocarbon group, 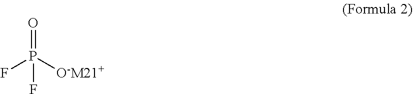
where M21⁺ is one of lithium ion (Li⁺) and sodium ion (Na⁺), 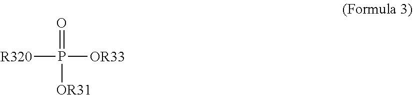
where each of R31, R32, and R33 is independently one of a monovalent hydrocarbon group and a monovalent fluorinated hydrocarbon group.

2. The electrolyte according to claim 1, wherein a content of the phosphite ester compound is in a range from 0.1 wt % to 20 wt %, inclusive, relative to a content of the non-aqueous solvent and the electrolyte salt in the electrolyte.

3. The electrolyte according to claim 1, wherein a content of the compound configured to form lithium and a complex and including a formation constant equal to or greater than 10² is in a range from 1 wt % to 5 wt %, inclusive, relative to a content of the non-aqueous solvent and the electrolyte salt in the electrolyte.

4. The electrolyte according to claim 1, wherein a content of the difluorophosphate is equal to or greater than 0.1 wt % relative to a content of the non-aqueous solvent and the electrolyte salt in the electrolyte.

5. The electrolyte according to claim 1, wherein a content of the phosphate ester compound is in a range from 1 wt % to 5 wt %, inclusive, relative to a content of the non-aqueous solvent and the electrolyte salt in the electrolyte.

6. An energy storage device comprising:
a positive electrode including a carbon material;
a negative electrode including a negative electrode material that is configured to adsorb and desorb lithium ion; and
an electrolyte,
the electrolyte including:
a non-aqueous solvent;
an electrolyte salt including LiPF₆; and
at least one compound selected from among a phosphite ester compound represented by a formula 4, a compound configured to form lithium and a complex and including a formation constant equal to or greater than 10² for forming a lithium complex, difluorophosphate represented by a formula 5, and a phosphate ester compound represented by a formula 6, the at least two compounds including at least the phosphite ester compound represented by the formula 4,
the carbon material at which functional groups exist, the functional groups at least including a lactone group arranged at a surface of the carbon material,
an amount of the phosphite ester compound contained in the electrolyte and represented by the formula 4 and a sum of amounts of a phenolic hydroxyl group and a carboxyl group existing at the carbon material and included in the functional groups satisfying a relational expression 1,
[An amount (mol) of the phosphite ester compound contained in the electrolyte and represented by the formula 4]=a1×[a sum of amounts (mol) of a phenolic hydroxyl group and a carboxyl group existing at the carbon material and included in the functional groups] (Relational expression 1)
where a coefficient a1 is equal to or greater than 1.67, 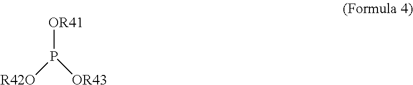
where each of R41, R42, and R43 is independently one of a monovalent hydrocarbon group and a monovalent fluorinated hydrocarbon group, 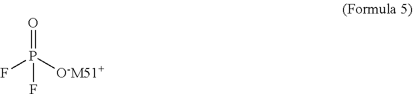
where M51⁺ is one of lithium ion (Li⁺) and sodium ion (Na⁺), 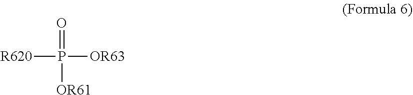
where each of R61, R62, and R63 is independently one of a monovalent hydrocarbon group and a monovalent fluorinated hydrocarbon group.

7. The energy storage device according to claim 6, wherein a mole percentage of an amount of the lactone group relative to a total amount of the functional groups is equal to or greater than 8 mol %.

8. The energy storage device according to claim 6, wherein the energy storage device is a lithium ion capacitor.

9. The energy storage device according to claim 6, wherein a content of the phosphite ester compound is in a range from 0.1 wt % to 20 wt %, inclusive, relative to a content of the non-aqueous solvent and the electrolyte salt in the electrolyte.

10. The energy storage device according to claim 6, wherein a content of the compound configured to form lithium and a complex and including a formation constant equal to or greater than 10² is in a range from 1 wt % to 5 wt %, inclusive, relative to a content of the non-aqueous solvent and the electrolyte salt in the electrolyte.

11. The energy storage device according to claim 6, wherein a content of the difluorophosphate is equal to or greater than 0.1 wt % relative to a content of the non-aqueous solvent and the electrolyte salt in the electrolyte.

12. The energy storage device according to claim 6, wherein a content of the phosphate ester compound is in a range from 1 wt % to 5 wt %, inclusive, relative to a content of the non-aqueous solvent and the electrolyte salt in the electrolyte.

13. A method of manufacturing an energy storage device, comprising:
assembling an energy storage device including a positive electrode, a negative electrode including a negative electrode material that is configured to adsorb and desorb lithium ion, and an electrolyte, the electrolyte including a non-aqueous solvent, an electrolyte salt including LiPF₆, and at least one compound selected from among a phosphite ester compound represented by a formula 7, a compound configured to form lithium and a complex and including a formation constant equal to or greater than 10² for forming a lithium complex, difluorophosphate represented by a formula 8, and a phosphate ester compound represented by a formula 9, the at least two compounds including at least the phosphite ester compound represented by the formula 7; and
performing an aging process where the assembled energy storage device is applied with a voltage and is left for a predetermined time period depending on a magnitude and a state of the applied voltage under temperature environment ranging from 80° C. to 120° C., inclusive, 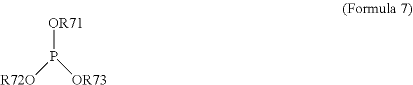
where each of R71, R72, and R73 is independently one of a monovalent hydrocarbon group and a monovalent fluorinated hydrocarbon group, 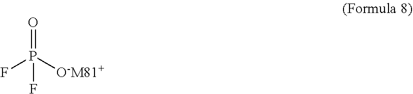
where M81⁺ is one of lithium ion (Li⁺) and sodium ion (Na⁺), 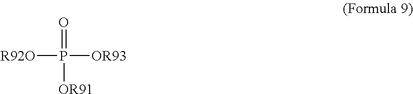
where each of R91, R92, and R93 is independently one of a monovalent hydrocarbon group and a monovalent fluorinated hydrocarbon group.

14. The manufacturing method according to claim 13, further comprising:
applying a voltage to the assembled energy storage device while the assembled energy storage device is being left in a manner that charging and discharging are repeatedly performed between a first SOC range where a state of charge of the assembled energy storage device is specified from 50% to 100%, inclusive, and a second SOC range where the state of charge of the assembled energy storage device is specified from 0% to 20%, inclusive.

15. The manufacturing method according to claim 14, wherein the predetermined time of the aging process is in a range from 5 hours to 17 hours, inclusive.

16. The manufacturing method according to claim 13, further comprising:
applying a voltage to the assembled energy storage device while the assembled energy storage device is being left in a manner that the applied voltage is retained at a voltage level selected from among voltages corresponding to a first SOC range where a state of charge of the assembled energy storage device is specified from 50% to 100%, inclusive.

17. The manufacturing method according to claim 16, wherein the predetermined time of the aging process is in a range from 50 hours to 153 hours, inclusive.
